(19) United States
(12) Patent Application Publication
(10) Pub. No.: US 2015/0331472 A1
(43) Pub. Date: Nov. 19, 2015

(54) DUAL POWER SUPPLY SYSTEM AND ELECTRICALLY DRIVEN VEHICLE

(71) Applicant: HONDA MOTOR CO., LTD., Tokyo (JP)

(72) Inventors: Jun IWAMOTO, Wako (JP); Kuniaki IKUI, Wako (JP); Takashi SONE, Wako (JP); Katsunori OKUBO, Wako (JP); Atsushi OTSU, Wako (JP)

(73) Assignee: HONDA MOTOR CO., LTD., Tokyo (JP)

(21) Appl. No.: 14/709,483

(22) Filed: May 12, 2015

(30) Foreign Application Priority Data
May 14, 2014 (JP) 2014-100208

(51) Int. Cl. G06F 1/32

(52) U.S. Cl. CPC G06F 1/3212; G06F 1/3287

(57) ABSTRACT

A dual power supply system includes a first power storage battery, a second power storage battery, and a power controller. The first power storage battery is to supply power to a load and has a first internal resistance. The second power storage battery is to supply power to the load and has a second internal resistance higher than the first internal resistance. The power controller is configured to control the second power storage battery to be charged and discharged. The power controller is configured to prohibit the second power storage battery from being charged while the load is in operation.

### CROSS-REFERENCE TO RELATED APPLICATIONS

The present application claims priority under 35 U.S.C. $119 to Japanese Patent Application No. 2014-100208, filed May 14, 2014, entitled “Dual Power Supply System and Electrically Driven Vehicle.” The contents of this application are incorporated herein by reference in their entirety.

### BACKGROUND

1. Field

The present disclosure relates to a dual power supply system and an electrically driven vehicle.

2. Description of the Related Art

In recent years, green wave campaign has been proposed and electrically driven vehicles having a superior environmental performance are receiving attention from the viewpoint of CO₂ emission reduction.

Here, the electrically driven vehicles include a so-called electric vehicle (EV) that uses a drive motor as a power source and uses power resources of at least a power storage battery. The electrically driven vehicles also include a hybrid vehicle (HEV), a plug-in hybrid vehicle (PHEV) and a fuel cell vehicle (FCV).

Japanese Unexamined Patent Application Publication (JP-A) No. 11-332023 proposes a battery for electric vehicles that includes a dual power supply system having a first power storage battery and a second power storage battery.

The battery for electric vehicles described in JP-A No. 11-332023 has a configuration in which a high output density secondary battery (lithium-ion battery) and a high energy density secondary battery (lithium-ion battery or lithium polymer battery) are connected in parallel, DC charge power of the parallel-connected secondary batteries is converted to AC power and supplied to a drive motor, and regenerative power, which is generated AC power of the drive motor, is converted to DC power and charged to the parallel-connected secondary batteries ([0013] in JP-A No. 11-332023).

### SUMMARY

According to one aspect of the present invention, a dual power supply system includes a load, a first power storage battery, a second power storage battery, and a power controller. The first power storage battery supplies power to the load. The second power storage battery supplies power to the load and has a higher internal resistance than the first power storage battery has. The power controller controls electrical discharge of at least the second power storage battery. When the load is in operation, the power controller does not charge the second power storage battery.

According to another aspect of the present invention, an electrically driven vehicle is equipped with the dual power supply system. A drive motor, the first power storage battery, and the second power storage battery are disposed in order from a front to a rear of the electrically driven vehicle.

According to further aspect of the present invention, a dual power supply system includes a first power storage battery, a second power storage battery, and a power controller. The first power storage battery is to supply power to a load and has a first internal resistance. The second power storage battery is to supply power to the load and has a second internal resistance higher than the first internal resistance. The power controller is configured to control the second power storage battery to be charged and discharged. The power controller is configured to prohibit the second power storage battery from being charged while the load is in operation.

According to the other aspect of the present invention, an electrically driven vehicle includes the dual power supply system. A drive motor, the first power storage battery, and the second power storage battery are disposed in order from a front to a rear of the electrically driven vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic circuit block diagram of an electrically driven vehicle provided with a dual power supply system according to an embodiment.

FIG. 2 is a schematic configuration diagram of the electrically driven vehicle.

FIG. 3 is a schematic circuit block diagram of the electrically driven vehicle when a converter operates as a voltage decrease converter in a voltage decrease mode.

FIG. 4 is an explanatory diagram of an operation details table in a voltage decrease mode.

FIG. 5A is a schematic operation explanatory diagram of the dual power supply system at the time of power running operation when the remaining capacity of the main battery is lower than a predetermined value, FIG. 5B is a schematic operation explanatory diagram of the dual power supply system at the time of regenerative operation when the remaining capacity of the main battery is lower than the predetermined value, FIG. 5C is a schematic operation explanatory diagram of the dual power supply system at the time of power running operation when the remaining capacity of the main battery is higher than the predetermined value, and FIG. 5D is a schematic operation explanatory diagram of the dual power supply system at the time of regenerative operation when the remaining capacity of the main battery is higher than the predetermined value.

FIG. 6 is a schematic circuit block diagram of the electrically driven vehicle when a converter operates as a voltage increase converter in a voltage increase mode.

FIG. 7 is an explanatory diagram of an operation details table in a voltage increase mode.

FIG. 8 is a characteristic graph illustrating change characteristic of internal resistance at the time of discharge and change characteristic of internal resistance at the time of charge in relation to the remaining capacity of the main battery.

FIG. 9 is a flow chart for explaining the operation of a sub battery at the time of voltage decrease when a sub battery voltage is higher than a main battery voltage.

FIG. 10 is a time chart for explaining the operation of the sub battery at the time of voltage decrease when the sub battery voltage is higher than the main battery voltage.

FIG. 11 is a flow chart for explaining the operation of the sub battery at the time of voltage increase when the sub battery voltage is lower than the main battery voltage.

FIG. 12 is a time chart for explaining the operation of the sub battery at the time of voltage increase when the sub battery voltage is lower than the main battery voltage.

FIG. 13 is a schematic operation explanatory diagram of the embodiment.

### DESCRIPTION OF THE EMBODIMENTS

The embodiments will now be described with reference to the accompanying drawings, wherein like reference numerals designate corresponding or identical elements throughout the various drawings.

Hereinafter, an embodiment of a dual power supply system according to the present disclosure will be given and described in detail with reference to the accompanying drawings.

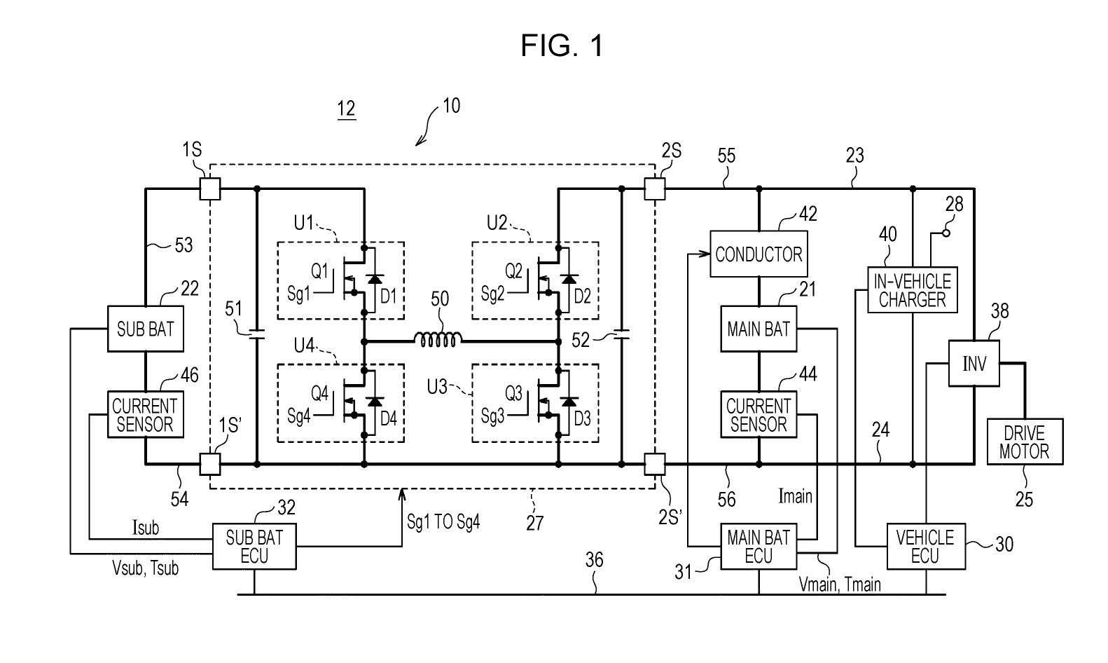

FIG. 1 is a schematic circuit block diagram of an electrically driven vehicle 12 provided with a dual power supply system 10 according to the embodiment.

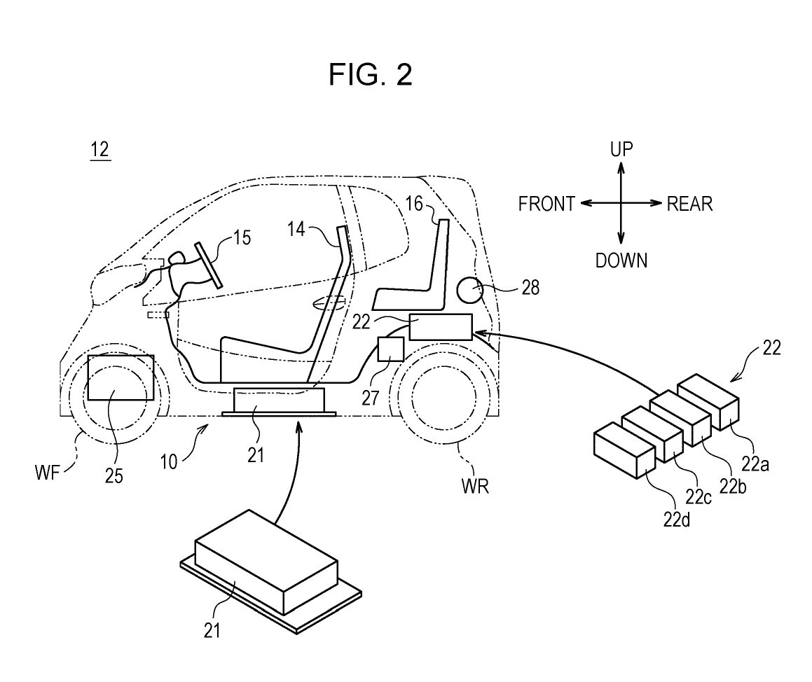

FIG. 2 is a schematic configuration diagram of a two-seater electrically driven vehicle 12 including a front seat 14 and a rear seat 16. In the electrically driven vehicle 12, a driver seated on the front seat 14 operates a steering 15 at the time of vehicle running.

In FIG. 2, in the electrically driven vehicle 12, there are disposed a more expensive main battery (main BAT) 21 having a relatively lower internal resistance and higher output, serving as a first power storage battery in an under floor portion under the front seat 14, and a less expensive sub battery (sub BAT) 22 having a relatively high internal resistance, serving as a second power storage battery on a chassis over rear wheels WR under the rear seat 16. The sub battery 22 is formed by connecting four sub batteries 22a, 22b, 22c, 22d in parallel and is provided for use. The sub battery 22, when being charged, may be charged not only by an in-vehicle charger 40, but also by an external charger (not illustrated) in a house or the like after the sub battery 22 is removed from the electrically driven vehicle 12.

In the electrically driven vehicle 12, a drive motor 25 that drives front wheels WF is disposed under the front hood, a converter 27 for DC voltage conversion is further disposed on the chassis in the vicinity of tire houses for the rear wheels WR, and a plug 28 for external charge is disposed in a rear portion of the electrically driven vehicle 12.

In this manner, in the electrically driven vehicle 12, the drive motor 25, the main battery 21, the converter 27, and the sub battery 22 are disposed in order from the front to the rear of the electrically driven vehicle 12. This disposition makes it possible to achieve the shortest wiring (line) length of lines 23, 24 (see FIG. 1), which are power lines between the drive motor 25 and the main battery 21, and to achieve the shortest wiring (line) length of lines (power lines) 55, 56, 53, 54 (see FIG. 1), which are power lines between the main battery 21 and the sub battery 22 through the converter 27.

In the case where the drive motor 25 is disposed in the vicinity of the rear wheels WR in order to drive the rear wheels WR, similarly to the above disposition, it possible to achieve the shortest wiring (line) length by disposing the drive motor 25, the main battery 21, the converter 27, and the sub battery 22 in order from the rear to the front of the electrically driven vehicle 12.

Also, the converter 27, a current sensor 46, and the sub battery ECU 32 may be integrally assembled to the sub battery 22 to produce a sub battery assembly. In this case, it is possible to achieve a more compact, simpler system configuration of the electrically driven vehicle 12.

As illustrated in FIG. 1, the dual power supply system 10 basically includes the drive motor 25 as a load (power running load, regenerative load); the main battery 21 which is capable of supplying (discharging) relatively high power to the drive motor 25 and to which regenerative power from the drive motor 25 is charged; the sub battery 22 which is capable of supplying (discharging) relatively low power to the drive motor 25 and of supplying power for charging the main battery 21; a converter 27 that is a voltage converter and also serves as a power controller, the voltage converter being operable to control its state between the sub battery 22 and the main battery 21 to be switched between direct connection state, voltage increase state, and voltage decrease state; and various types of electronic control units (ECU) 30 to 32.

The ECUs 30 to 32 are connected to a communication line 36 in common, thereby allowing various data to be shared between the units via the communication line 36, and additionally allowing communication such as transmitting and receiving of command signals and acknowledgement signals to be performed between the units. It is to be noted that the various data includes data from the various sensors described below.

The secondary sides 2S, 2S′ of the converter 27 are connected to the drive motor 25 via the lines 55, 56 and the lines 23, 24, which are power lines, through an inverter (INV) 38 which is a DC/AC inverter. The main battery 21, which is connected to the secondary sides 2S, 2S′ of the converter 27 via the lines 55, 56, is connected to the drive motor 25 via the lines 23, 24 through the INV 38.

The in-vehicle charger 40 is disposed between the lines 23 and 24. The in-vehicle charger 40 is connected to the plug 28 for external charge.

The in-vehicle charger 40 and the INV 38 are controlled by the vehicle ECU 30.

The INV 38 has, for example, a 3-phase full bridge circuit configuration, and at the time of acceleration and at the time of uniform speed running (at the time of power running operation), the INV 38 converts a DC voltage to an AC voltage and applies the AC voltage to the drive motor 25, the DC voltage being generated in the secondary sides 2S, 2S′ by the main battery 21, whereas at the time of deceleration (at the time of regenerative operation), the INV 38 converts regenerative power (AC voltage) generated by the drive motor 25 to DC voltage regenerative power and supplies the regenerative power to the main battery 21.

The main battery 21 is connected in series to a conductor 42 and a current sensor 44, the conductor 42 also serving as a starting switch (power switch), and the main battery 21 and the conductor 42 are controlled and managed by the main battery ECU 31. A value of charge or discharge current to or from the main battery 21 is taken to the main battery ECU 31 as a main battery current value Imain, the value of charge or discharge current being detected by the current sensor 44.

In addition, an inter-terminal voltage value (main battery voltage value, main battery voltage) Vmain of the main battery 21 and a temperature value (main battery temperature value, main battery temperature) Tmain are also taken to the main battery ECU 31 via a voltage sensor and a temperature sensor which are not illustrated. Therefore, the main battery ECU 31 is capable of calculating and controlling a SOC (referred to as a SOCm or a main battery remaining capacity SOCm) that is the remaining capacity of the main battery 21.

On the other hand, the sub battery 22 connected between primary sides 1S, 1S′ of the converter 27 is connected in series to the current sensor 46, and the sub battery 22 is controlled and managed by the sub battery ECU 32. A value of discharge current from the sub battery 22 is taken to the sub battery ECU 32 as a sub battery current value Isub, the value of discharge current being detected by the current sensor 46.

In addition, an inter-terminal voltage value (sub battery voltage value, sub battery voltage) Vsub of the sub battery 22 and a temperature value (sub battery temperature value, sub battery temperature) Tsub are taken to the sub battery ECU 32 via a voltage sensor and a temperature sensor which are not illustrated. Therefore, the sub battery ECU 32 is capable of calculating and controlling a SOC (referred to as SOCs or sub battery remaining capacity SOCs) that is the remaining capacity of the sub battery 22.

The converter 27 is a publicly known H-type voltage increase/decrease converter and includes transistors Q1, Q2, Q3, Q4, diodes D1, D2, D3, D4, and a reactor 50, the transistors Q1, Q2, Q3, Q4 being switching elements such as a MOSFET or an IGBT to be ON/OFF controlled according to the levels of gate drive signals Sg1, Sg2, Sg3, Sg4 from the sub battery ECU 32, the diodes D1, D2, D3, D4 being connected reversely to the transistors Q1 to Q4, respectively. It is to be noted that in this embodiment, MOSFET is used as illustrated by the element symbol in FIG. 1.

The transistor Q1 and the diode D1 constitute an upper arm element U1 of the primary sides 1S, 1S′, and the transistor Q2 and the diode D2 constitute an upper arm element U2 of the secondary sides 2S, 2S′. Also, the transistor Q3 and the diode D3 constitute a lower arm element U3 of the secondary sides 2S, 2S′, and the transistor Q4 and the diode D4 constitute a lower arm element U4 of the primary sides 1S, 1S′.

The gate drive signals Sg1 to Sg4 are supplied to the respective transistors Q1 to Q4 from the sub battery ECU 32, the gate drive signals Sg1 to Sg4 corresponding to an operational mode (the later-described voltage decrease mode, voltage increase mode, or direct connection mode) of the converter 27.

The reactor 50 is connected to a middle point between the upper arm element U1 and the lower arm element U4 of the primary sides 1S, 1S′ and to a middle point between the upper arm element U2 and the lower arm element U3 of the secondary sides 2S, 2S′.

Smoothing capacitors 51, 52 are connected between the primary sides 1S, 15′ and between the secondary sides 2S, 2S′.

The vehicle ECU 30, the main battery ECU 31, and the sub battery ECU 32 described above are each a computer including a microcomputer and has a central processing unit (CPU), a ROM (also including an EEPROM) which is a memory, a random access memory (RAM), an input/output device such as an A/D converter, a D/A converter, and a timer serving as a time measurement unit. The CPU functions as various function achieving parts (function achieving units), for example, a controller, an operation unit, and a processing unit by reading and executing programs recorded on the ROM.

In this embodiment, the main battery ECU 31 and the vehicle ECU 30 included in the dual power supply system 10 may be an integrated component and the sub battery ECU 32 and the converter 27 included in the dual power supply system 10 may be an integrated component.

Hereinafter, the circuit operation in each operational mode of the converter 27 will be described in order of A. voltage decrease mode to B. voltage increase mode.

A. Voltage decrease mode of the converter 27 In this case, the sub battery voltage Vsub is set to be higher (Vsub>Vmain) than the main battery voltage Vmain. Specifically, such a relationship between voltages is achieved by adjusting the number of cells included in the main battery and the sub battery.

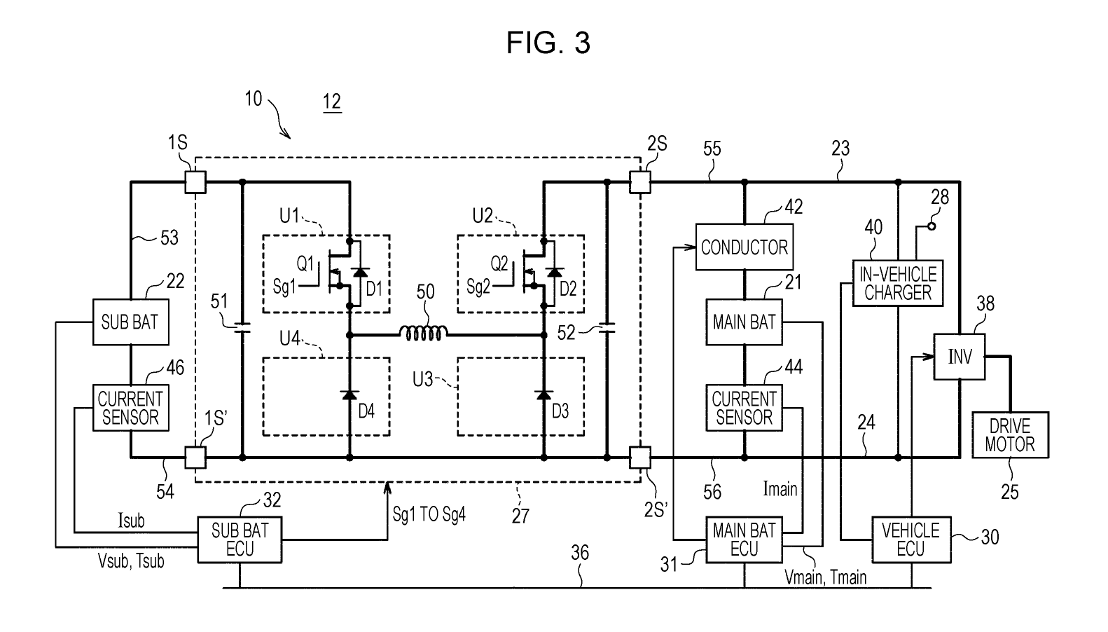

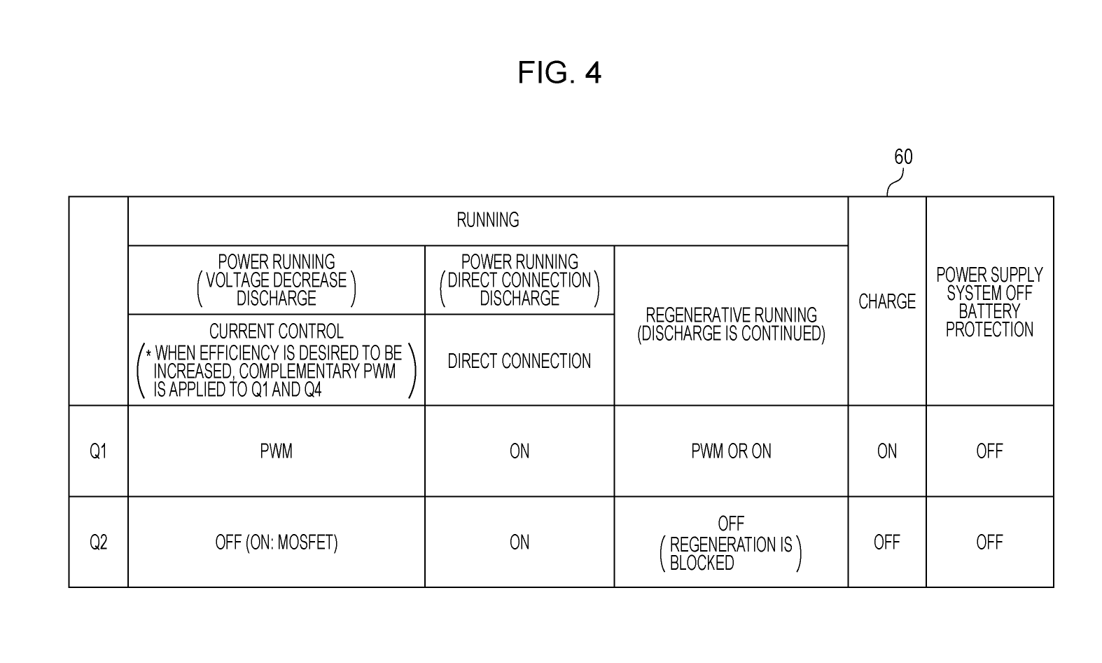

The operation in the operational mode (voltage decrease mode) in which the converter 27 functions as a voltage decrease converter relative to the battery voltage Vsub will be described with reference to the schematic circuit block diagram (basically, the transistors Q3, Q4 included in the lower arm elements U3, U4 are both OFF) in FIG. 3 that indicates the wire connection state of the voltage decrease converter in the converter 27, and the operation details table 60 of FIG. 4 in voltage decrease mode, the table 60 being stored in the ROM of the sub battery ECU 32.

In a power running state (voltage decrease discharge, direct connection discharge) at the time of running, when the sub battery voltage Vsub and the main battery voltage Vmain (Vsub>Vmain) are getting close to each other, the sub battery ECU 32 sets the transistors Q1, Q2=ON (direct connection state, direct connection mode) so that discharge current (direct connection discharge current) from the sub battery 22 is supplied to the secondary sides 2S, 2S′ through the transistor Q1, the reactor 50, and the diode D2. When the sub battery 22 is discharged with voltage decrease, Vsub>Vmain, and current does not flow backward even when Q2=ON. It is possible to reduce the switching loss of the converter 27 to zero value by setting the converter 27 in a direct connection state.

In a power running state at the time of running (voltage decrease discharge, current control), when the discharge current flowing out from the sub battery 22 is controlled while the sub battery voltage Vsub is decreased, the transistor Q1 is controlled so that Q1=pulse width modulation (PWM) and the transistor Q2=OFF. Since the transistor Q2 is a MOSFET, current control is performed such that Q2=ON at the time of discharge and Q2=OFF only at the time of regeneration, thereby making it possible to eliminate power loss (power loss in the forward direction) due to the diode D2 and to increase the power utilization efficiency of the sub battery 22.

While the transistor Q1 performs PWM control, at the time of ON of the transistor Q1, the discharge current from the sub battery 22 is supplied to the secondary sides 2S, 2S′ through the transistor Q1, the reactor 50, and the transistor Q2 (diode D2), whereas at the time of OFF of the transistor Q1, electric energy stored in the reactor 50 is supplied to the secondary sides 2S, 2S′ through the diode D4, the reactor 50, and the transistor Q2 (diode D2).

While PWM control is performed by the transistor Q1, complementary PWM control is performed such that the transistor Q4 is set ON or OFF corresponding to OFF or ON of the transistor Q1, thereby making it possible to efficiently supply the electric energy stored in the reactor 50 to the secondary sides 2S, 2S′.

Next, in a regenerative state at the time of running (discharge is continued), the transistor Q2 is set so that Q2=OFF, and thus regenerative power supplied from the drive motor 25 through the inverter 38 is blocked (shut off) by the diode D2 and is charged to the main battery 21 only, the transistor Q1 is set to PWM control state or ON state so that the sub battery 22 is not set to OFF state (discharge state is continued), and discharge current from the sub battery 22 is controlled so that the discharge current is charged to the main battery 21 through the transistor Q1 and the diode D2.

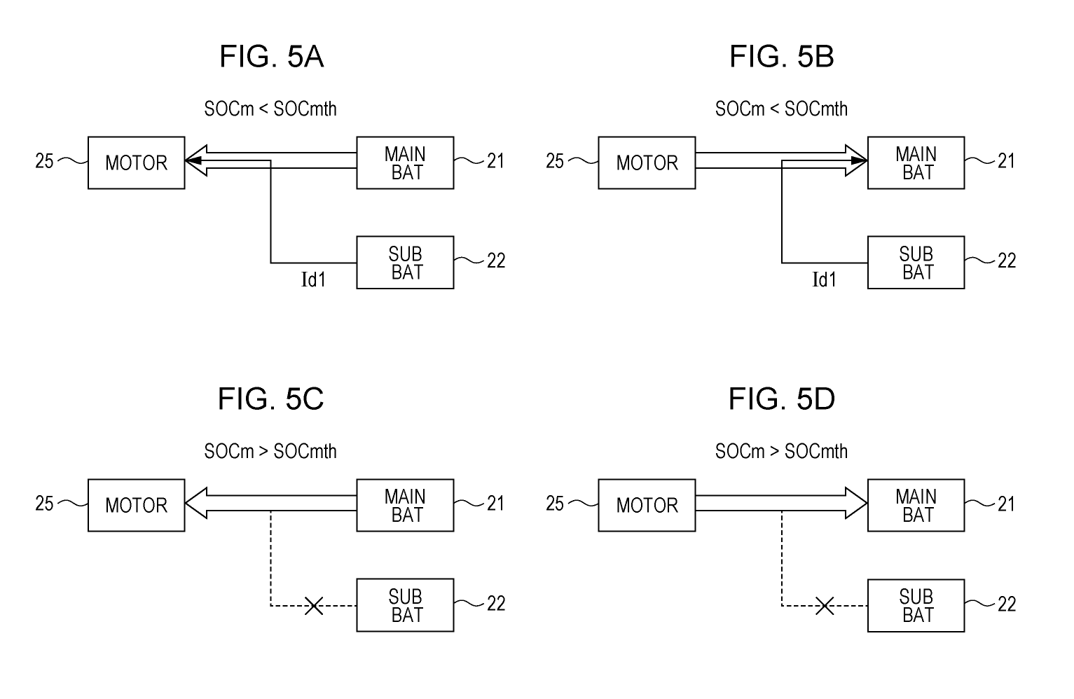

As described above, in a power running state at the time of running, when the main battery remaining capacity SOCm of the main battery 21 falls below a threshold remaining capacity SOCmth (which will be described later) as illustrated in FIG. 5A, or when the voltage difference between the main battery 21 and the sub battery 22 is higher than a threshold value (Vsub−Vmain>ΔVstartth1 as described later), current control is performed such that a current is supplied from the main battery 21 to the drive motor 25 and a uniform current Id1 (described later) lower than or equal to the rated current is supplied from the sub battery 22 to the drive motor 25.

In a regenerative state at the time of running, current control is performed such that all regenerative current is charged to the main battery 21 as illustrated in FIG. 5B and the uniform current Id1 is supplied to the main battery 21 without stopping discharge of the sub battery 22.

Under this control, the sub battery 22 causes the uniform current Id1 lower than the rated current to flow continuously, and thus frequency of repeating discharge start and discharge stop for the sub battery 22 is reduced and change in the amount of discharge of the sub battery 22 is also reduced. Consequently, there is no increase in resistance when discharge is started or when the amount of discharge changes, and thus heat generation of the sub battery 22 may be reduced.

In a power running state at the time of running, when the main battery remaining capacity SOCm of the main battery 21 exceeds the threshold remaining capacity SOCmth (SOCm>SOCmth) as illustrated in FIG. 5C, or when the voltage difference between the main battery 21 and the sub battery 22 is lower than a threshold value (Vmain−Vsub<ΔVstartth2 as described later), current control is performed such that a current is supplied from the main battery 21 to the drive motor 25 and no current is supplied from the sub battery 22 to the drive motor 25 (the sub battery 22 is set to a non-operating state).

In a regenerative state at the time of running, current control is performed such that all regenerative current is charged to the main battery 21 as illustrated in FIG. 5D and no current is supplied from the sub battery 22 (the sub battery 22 is set to a non-operating state). Under this control, the dual power supply system 10 performs charge and discharge only by the main battery 21 having a low resistance, and thus heat generation is reduced and the sub battery 22 is not operated. Consequently the system efficiency, which is the total efficiency of the dual power supply system 10, may be increased.

Next, when the main battery 21 is charged by the in-vehicle charger 40 while a vehicle is stopped, charge current caused by external power is supplied to the main battery 21 through the plug 28 and the in-vehicle charger 40 and is also supplied to the sub battery 22 in consideration of SOCm of the main battery 21.

When the electrically driven vehicle 12 is parked after a vehicle is stopped, the conductor 42 is set to an open state and the transistors Q1, Q2 are set so that Q1, Q2=OFF, both the main battery 21 and the sub battery 22 are set to OFF state, and the dual power supply system 10 is set to battery protection state.

So far, A. The circuit operation in voltage decrease mode of the converter 27 has been described.

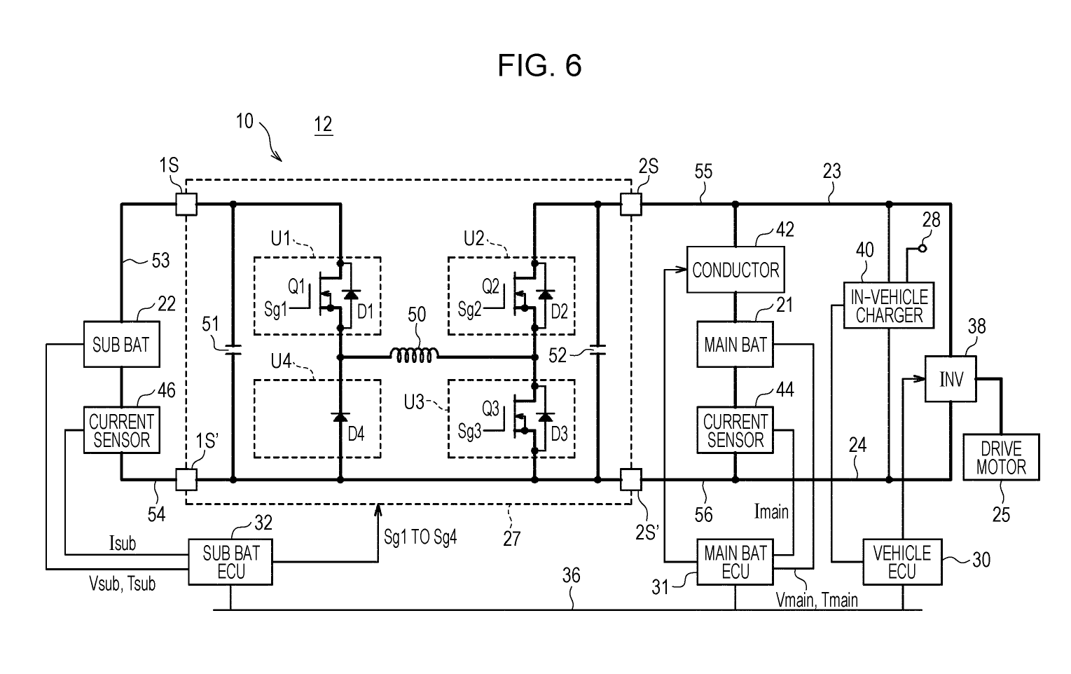

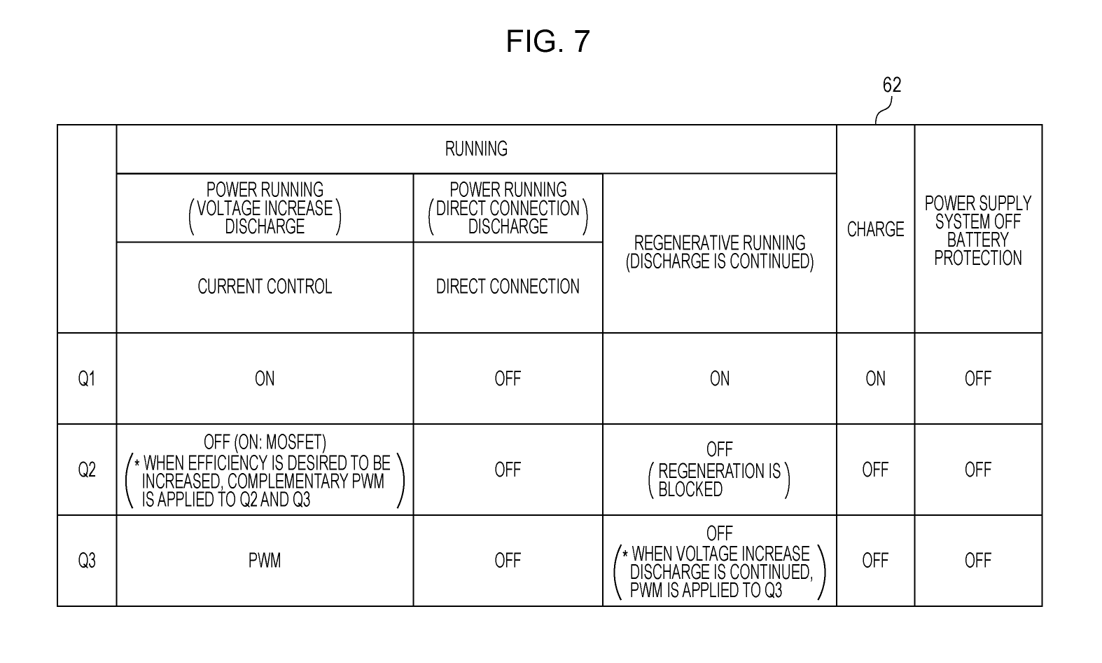

B. Voltage increase mode in the converter 27 Next, the operation in the operational mode (voltage increase mode) in which the converter 27 functions as a voltage increase converter will be described with reference to the schematic circuit block diagram of FIG. 6 (basically, Q4=OFF in the transistor Q4 included in the lower arm elements U4) and the operation details table 62 of FIG. 7. In this case, the sub battery voltage Vsub is set to be lower than the main battery voltage Vmain. Specifically, such a relationship between voltages is achieved by adjusting the number of cells included in the main battery 21 and the sub battery 22.

In a power running state (voltage increase discharge, direct connection discharge) at the time of running, when the sub battery voltage Vsub is lower than the main battery voltage Vmain (Vsub<Vmain), direct connection state is not assumed, and thus Q1 to Q3 are set so that Q1 to Q3=OFF.

In a power running state at the time of running (voltage increase discharge), when the discharge current flowing out from the sub battery 22 is controlled by increasing the sub battery voltage Vsub up to the main battery voltage Vmain, the transistor Q1 is set so that Q1=ON, the transistor Q2 is set so that Q2=OFF (since the transistor Q2 is a MOSFET, similarly to the voltage decrease mode, it is possible to set that Q2=ON at the time of discharge and Q2=OFF only at the time of regeneration), and the transistor Q3 is PWM controlled, and thus at the time of Q1=ON and Q3=ON, energy is stored in the reactor 50 by discharge current of the sub battery 22, and at the time of Q1=ON and Q3=OFF, the energy stored in the reactor 50 is supplied to the secondary sides 2S, 2S′ of the converter 27 through the diode D4, the reactor 50, and the diode D2.

Also in this case, complementary PWM control is performed such that the transistor Q2 is set ON or OFF corresponding to OFF or ON of the transistor Q3, thereby making it possible to efficiently supply the electric energy stored in the reactor 50 to the secondary sides 2S, 2S′.

In a regenerative state at the time of running, when no discharge current is allowed to flow from the sub battery 22, the transistors Q2, Q3 are set so that Q2, Q3=OFF, and thus regenerative power supplied from the drive motor 25 through the inverter 38 is shut off (blocked) by the diode D2 and is charged to the main battery 21 only. When a MOSFET is used for Q2, current control is performed such that Q2=ON at the time of discharge and Q2=OFF only at the time of regeneration, thereby making it possible to eliminate power loss due to the diode D2 and to increase the power utilization efficiency.

On the other hand, in a regenerative state at the time of running, when discharge current is caused to flow continuously from the sub battery 22, the transistor Q1 is set to ON state so that the sub battery 22 is not set to OFF state, the transistor Q3 is controlled so that Q3=PWM state to continue to increase the sub battery voltage Vsub, and discharge current from the sub battery 22 is controlled so that the discharge current is charged to the main battery 21 through the transistor Q1 and the diode D2.

When the main battery 21 is charged by the in-vehicle charger 40 while a vehicle is stopped, charge current caused by external power is supplied to the main battery 21 through the plug 28 and the in-vehicle charger 40 and is also supplied to the sub battery 22 in consideration of SOCm of the main battery 21.

When the electrically driven vehicle 12 is parked after a vehicle is stopped, the conductor 42 is set in an open state and the transistors Q1, Q2, Q3 are set so that Q1, Q2, Q3=OFF, both the main battery 21 and the sub battery 22 are set in OFF state, and the dual power supply system 10 is set in battery protection state.

So far, B. The circuit operation in voltage increase mode of the converter 27 has been described.

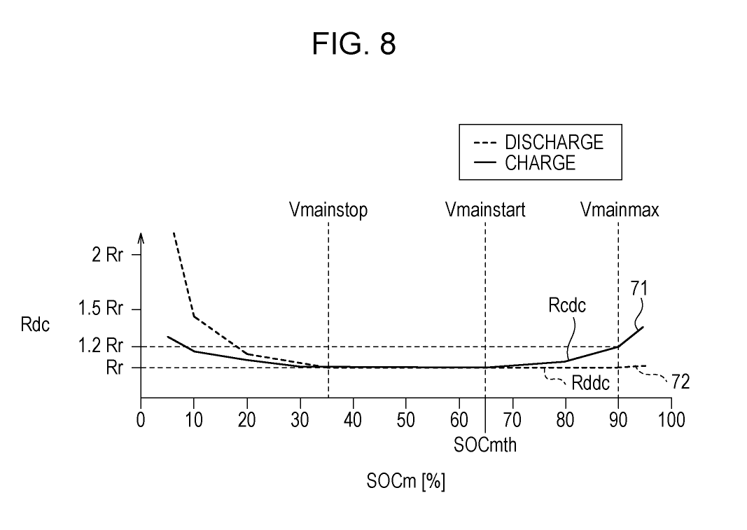

As an example, FIG. 8 illustrates typical characteristics 71, 72 that each indicate change in DC internal resistance Rdc (an internal resistance Rcdc at the time of charge and an internal resistance Rddc at the time of discharge) in relation to a change in the main battery remaining capacity SOCm [%] of the main battery 21 when the battery temperature Tmain of the main battery 21 is at room temperature (Tmain=25° C.)

When the main battery remaining capacity SOCm is in a range of 35% to 70% (the main battery voltage Vmain is between Vmainstop and Vmainstart), both the internal resistance Rcdc indicated by a solid line and the internal resistance Rddc indicated by a dashed line provide the lowest internal resistance Rdc and a sufficiently small reference resistance value (reference value) Rr.

It is to be noted that even when the main battery remaining capacity SOCm increases up to approximately 90% (the main battery voltage Vmain increases up to approximately Vmainmax), the internal resistance Rddc at the time of discharge does not change from the reference resistance value Rr, whereas for the internal resistance Rcdc at the time of charge, the internal resistance Rdc increases up to an internal resistance 1.2 Rr which is approximately 1.2 times the reference resistance value Rr. Also, it is to be noted that when the main battery remaining capacity SOCm is less than or equal to 35%, both the internal resistance Rcdc at the time of charge and the internal resistance Rddc at the time of discharge increase from the reference resistance value Rr. In this embodiment, the sub battery 22 is used where SOCm of the main battery 21 is in a range of approximately 35% (Vmain=Vmainstop) to 90% (Vmain=Vmainmax).

Here, the voltage of Vmain=Vmainstop is referred to as usable lower limit voltage of the main battery 21. In this embodiment, usable lower limit voltage of the sub battery 22 is set to Vsub=Vsubstop (described later). In this embodiment, the relationship between the voltages is Vmainstop<Vsubstop<Vmainstart<Vmainmax.

Next, the details of discharge operation of the sub battery 22 of the electrically driven vehicle 12 equipped with the dual power supply system 10 according to this embodiment that basically has the above configuration and operation will be described in detail with reference to C. the operation flow chart and time chart of the sub battery 22 at the time of voltage decrease (the converter 27 is operated as a voltage decrease converter) and D. the operation flow chart and time chart of the sub battery 22 at the time of voltage increase (the converter 27 is operated as a voltage increase converter). The operations themselves of the voltage decrease converter, the voltage increase converter, and direct connection of the converter 27 have been already described, and thus are omitted or briefly described.

C. The detailed operation of the sub battery 22 at the time of voltage decrease

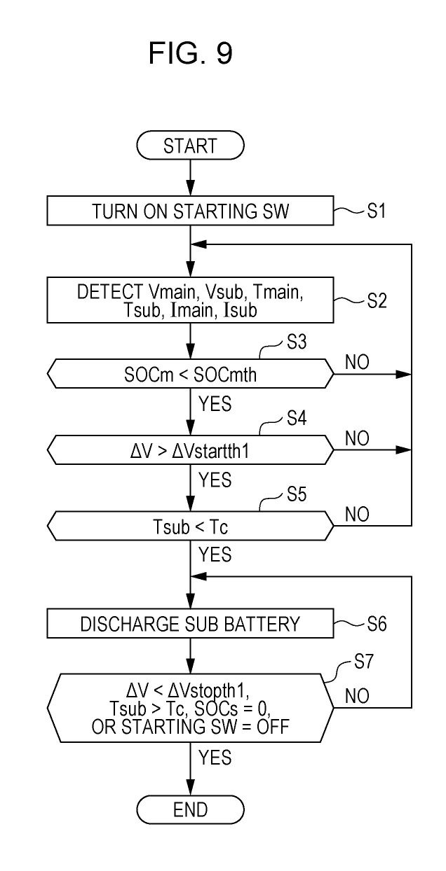

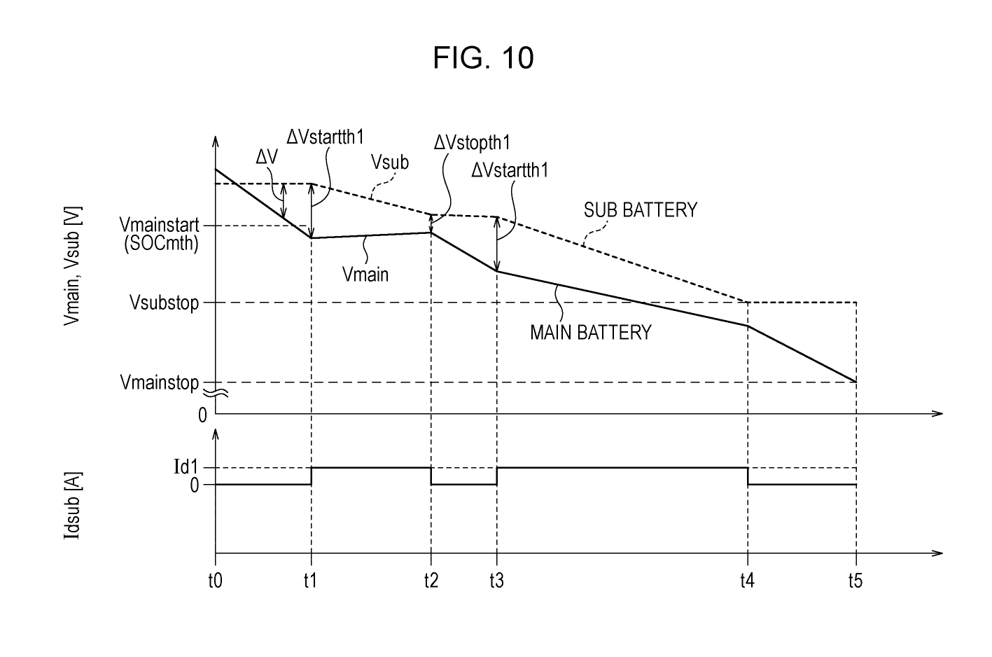

The operation of the sub battery 22 at the time of voltage decrease when the sub battery voltage Vsub is higher than the main battery voltage Vmain (Vsub>Vmain) will be described with reference to the flow chart of FIG. 9 and the time chart of FIG. 10. It is to be noted that the execution entity of the program according to the flow chart of FIG. 9 is the sub battery ECU 32. Also, a processing period from determination processing in step S1 of the flow chart of FIG. 9 back to the determination processing in step S1 is an extremely short time interval that does not interfere with the running of the electrically driven vehicle 12, and the processing is repeatedly executed.

In step S1, when a drive switch (starting SW, not illustrated) is in ON state, the drive switch corresponding to an ignition switch that switches from operation stop of the drive motor 25 which is the drive source of the electrically driven vehicle 12, for example, during running, in step S2, the sub battery ECU 32 detects the sub battery voltage value Vsub, the sub battery temperature value Tsub, and the sub battery current value Isub of the sub battery 22 at extremely short time intervals.

On the other hand, in step S2, the main battery ECU 31 detects the main battery voltage value Vmain, the main battery temperature value Tmain, and the main battery current value Imain of the main battery 21, and the sub battery ECU 32 takes the main battery voltage value Vmain and the main battery temperature value Tmain via the communication line 36. The processing of detection of voltage and temperature by various sensors in step S2 is executed at the extremely short time intervals while the starting SW is in ON state.

In the following description, transmission and receiving of data and transmission and receiving of commands via the communication line 36 are basically omitted in order to avoid complicatedness.

Subsequently, in step S3, it is determined whether or not the remaining capacity SOCm of the main battery 21 falls below the threshold remaining capacity SOCmth at which the internal resistance Rdc decreases to the reference resistance value Rr. When the remaining capacity SOCm does not fall below the threshold remaining capacity SOCmth (NO in step S3), the flow returns to step S2, and when the remaining capacity SOCm falls below the threshold remaining capacity SOCmth (YES in step S3), in step S4, the sub battery ECU 32 calculates the difference voltage ΔV (ΔV=Vsub−Vmain) between the main battery voltage Vmain and the sub battery voltage Vsub, and determines whether or not the calculated difference voltage ΔV exceeds a discharge start difference voltage threshold value ΔVstartth1 of the sub battery 22.

Here, regarding the discharge start difference voltage threshold value ΔVstartth1 of the sub battery 22, for example, a lower limit of the difference voltage ΔV is determined in consideration of a voltage detection error and a range of rapid fluctuation of voltage at the time of actual use in order to enable intended discharge control reliably. An upper limit of the difference voltage ΔV is determined in consideration of prediction or the like of voltage reduction of the main battery 21 so as to avoid increase of resistance value due to an intermittent operation of the sub battery 22 at a short interval.

Also, when the sub battery 22 is discharged in combination of voltage increase and voltage decrease, the discharge may be made irrespective of the main battery voltage Vmain, and thus the difference voltage ΔV does not have to be calculated.

When the determination in step S4 is negative (NO in step S4), the flow returns to step S2, and when the determination in step S4 is affirmative (YES in step S4), the sub battery ECU 32 determines whether or not the sub battery temperature Tsub falls below the upper limit temperature To (Tsub<Tc). The upper limit temperature To is set to a temperature beforehand such that when the sub battery temperature Tsub exceeds the temperature, deterioration of the sub battery 22 is promoted.

When the sub battery temperature Tsub does not fall below the upper limit temperature To (NO in step S5), the flow returns to step S2, and when it is determined that the sub battery temperature Tsub falls below the upper limit temperature Tc (YES in step S5), in step S6, discharge from the sub battery 22 with the uniform current Id1 lower than or equal to the rated current is started (at time t1).

Subsequently, in step S7, it is determined whether or not the sub battery voltage Vsub decreases due to discharge and the difference voltage ΔV falls below a discharge suspension (stop) threshold value difference voltage ΔVstopth1, whether or not the sub battery temperature Tsub increases due to discharge and the difference voltage ΔV exceeds the upper limit temperature Tc, whether or not the remaining capacity SOCs of the sub battery 22 have zero values (SOCs=0), or whether or not the starting SW is OFF. When each determination is negative (NO in step S7), the discharge from the sub battery 22 started in step S6 is continued, and when any determination is affirmative (YES in step S7), discharge from the sub battery 22 is suspended. For example, the difference voltage ΔV falls below the discharge suspension threshold value difference voltage ΔVstopth1, and discharge from the sub battery 22 is suspended (stopped) (at time t2).

For example, in a voltage difference area that does not allow discharge due to voltage drop of the converter 27, discharge has to be reliably stopped because small discharge and charge may be repeated, and thus the discharge suspension threshold value difference voltage ΔVstopth1 of the sub battery 22 is determined in consideration of a voltage detection error and a range of rapid fluctuation of voltage at the time of actual use.

Hereinafter, at time t3, determination in each of step S3, S4, and S5 is affirmative, and at time t4, although not reflected in the flow chart, the sub battery voltage Vsub becomes equal to the sub battery stop voltage Vsubstop and discharge is stopped. At time t5, the main battery voltage Vmain becomes equal to the main battery stop voltage Vmainstop, and thus discharge is stopped.

So far, C. The detailed operation of the sub battery 22 at the time of voltage decrease has been described.

D. The detailed operation of the sub battery 22 at the time of voltage increase

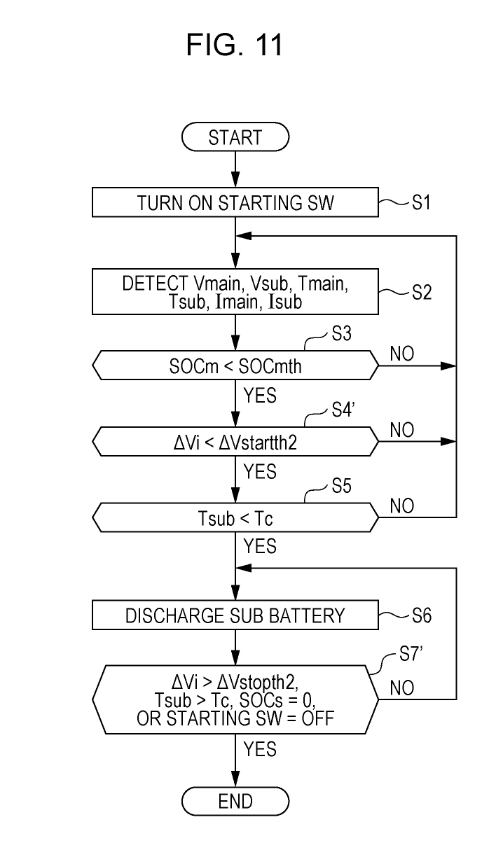

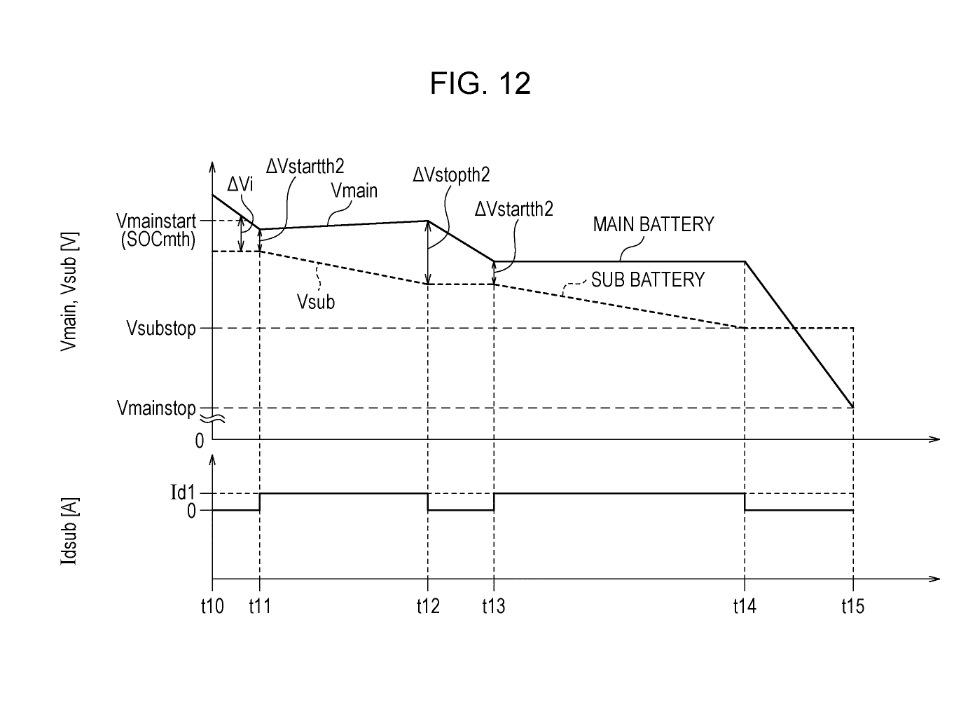

Next, the operation of the sub battery 22 at the time of voltage increase when the sub battery voltage Vsub is lower than the main battery voltage Vmain will be described with reference to the flow chart of FIG. 11 performed by the sub battery ECU 32 and the time chart of FIG. 12. The processing in the flow chart of FIG. 11 differs from the processing in the flow chart of FIG. 9 in that the processing in step S4 and S7 is replaced by the processing in step S4′ and S7′, and thus the processing in the remaining steps is omitted or briefly described.

In step S1 of FIG. 11, when the starting SW of the electrically driven vehicle 12 is in ON state, in step S2, in addition to the sub battery voltage value Vsub, the sub battery temperature value Tsub, and the sub battery current value Isub, the main battery voltage value Vmain, the main battery temperature value Tmain, and the main battery current value Imain are detected.

Subsequently, in step S3, it is determined whether or not the remaining capacity SOCm of the main battery 21 falls below the threshold remaining capacity SOCmth at which the internal resistance Rdc decreases to the reference resistance value Rr. When the remaining capacity SOCm does not fall below the threshold remaining capacity SOCmth (NO in step S3), the flow returns to step S2, and when the remaining capacity SOCm falls below the threshold remaining capacity SOCmth (YES in step S3), in step S4′, the sub battery ECU 32 calculates the difference voltage ΔVi (ΔVi=Vmain−Vsub) between the main battery voltage Vmain and the sub battery voltage Vsub, and determines whether or not the calculated difference voltage ΔVi falls below a discharge start difference voltage threshold value ΔVstartth2 of the sub battery 22.

Here, regarding the discharge start difference voltage threshold value ΔVstartth2 of the sub battery 22, for example, a lower limit of the difference voltage ΔV is determined in consideration of a voltage detection error and a range of rapid fluctuation of voltage at the time of actual use in order to enable intended discharge control reliably. An upper limit of the difference voltage ΔV is determined in consideration of prediction or the like of voltage reduction of the main battery 21 so as to avoid increase of resistance value due to an intermittent operation of the sub battery 22 at a short interval.

When the determination in step S4′ is negative (NO in step S4′), the flow returns to step S2, and when the determination in step S4′ is affirmative (YES in step S4′), the sub battery ECU 32 determines whether or not the sub battery temperature Tsub falls below the upper limit temperature To (Tsub<Tc).

When the sub battery temperature Tsub does not fall below the upper limit temperature Tc, the flow returns to step S2, and when it is determined that the sub battery temperature Tsub falls below the upper limit temperature To (YES in step S5), in step S6, discharge from the sub battery 22 with the uniform current Id1 is started (at time t11).

Subsequently, in step S7′, it is determined whether or not the sub battery voltage Vsub decreases due to discharge and the difference voltage ΔVi exceeds a discharge suspension (stop) threshold value difference voltage ΔVstopth2, whether or not the sub battery temperature Tsub increases due to discharge and the difference voltage ΔV exceeds the upper limit temperature Tc, whether or not the remaining capacity SOCs of the sub battery 22 are zero (SOCs=0), or whether or not the starting SW is OFF. When each determination is negative (NO in step S7′), the discharge from the sub battery 22 started in step S6 is continued, and when any determination is affirmative (YES in step S7′), discharge from the sub battery 22 is suspended. For example, FIG. 12 illustrates a case where the sub battery voltage Vsub decreases due to discharge and the difference voltage ΔVi exceeds the discharge suspension threshold value difference voltage ΔVstopth2 (at time t12).

Here, the discharge suspension threshold value difference voltage ΔVstopth2 of the sub battery 22 is determined in consideration of, for example, the voltage conversion loss of the converter 27.

Hereinafter, at time t13, determination in each of step S4′ and S5 is affirmative, and at time t14, although not reflected in the flow chart, the sub battery voltage Vsub becomes equal to the sub battery stop voltage Vsubstop and discharge is stopped. At time t15, the main battery voltage Vmain becomes equal to the main battery stop voltage Vmainstop, and thus discharge is stopped.

### Summary of Embodiment

As described above, the dual power supply system 10, which is applied to the aforementioned electrically driven vehicle 12 and is according to this embodiment, includes the drive motor 25 as a load, the main battery 21 that supplies power to the drive motor 25 as the first power storage battery, the sub battery 22 that supplies power to the drive motor 25 as the second power storage battery and has a higher internal resistance than the main battery 21, and the sub battery ECU 32 that controls discharge of at least the sub battery 22 as the power controller.

The converter 27 controlled by the sub battery ECU 32 is controlled in one of the voltage decrease mode (in which the converter 27 functions as a voltage decrease converter), the voltage increase mode (in which the converter 27 functions as a voltage increase converter), and the direct connection mode in a direction from the primary sides 1S, 1S′ on which the sub battery 22 is disposed to the secondary sides 2S, 2S′ on which the main battery 21 is disposed. On the secondary sides 2S, 2S′, the drive motor 25 is disposed via the inverter 38 which is a DC/AC inverter.

In this embodiment, although the power controller includes the sub battery ECU 32 and the converter 27, the power controller may include the sub battery ECU 32 or the converter 27.

When the drive motor 25 is in regenerative operation, the sub battery ECU 32 sets the transistor Q2 included in the converter 27 so that Q2=OFF, and regenerative current supplied from the drive motor 25 to the secondary sides 2S, 2S′ via the inverter 38 is blocked by the diode D2 that functions as a current breaker and the sub battery 22 is not charged. Thus, occurrence of Joule heat due to charge current of the sub battery 22 having a higher internal resistance may be reduced and temperature rise of the sub battery 22 is reduced. Consequently, deterioration of the sub battery 22 may be reduced. The sub battery 22 having a higher internal resistance compared with the main battery 21 has increased internal resistance particularly at the initial time after charging starts, and thus deterioration may be effectively reduced (avoided).

Even when a regenerative current occurs, for example, between times t1 and t2 (times t11 and t12) and between times t3 and t4 (times t13 and t14) during which the sub battery 22 is discharged, the regenerative current is blocked by the diode D2 and all the regenerative current is charged to the main battery 21 having a lower internal resistance. Thus, occurrence of power loss due to repetition of transient state (charging) of the sub battery 22 is avoidable beforehand and temperature rise of the sub battery 22 is reduced. Thus deterioration of the sub battery 22 may be reduced (avoided).

Here, preferably, when each of discharge start conditions (step S3, S4, S4′, S5) is satisfied, the sub battery ECU 32 starts to discharge the sub battery 22, and continues to discharge the sub battery 22, until discharge termination condition (step S7, S7′) is satisfied.

In this manner, once the sub battery 22 starts to discharge, while discharge is made as well as while power is regenerated from the drive motor 25 which is a load to the main battery 21, the sub battery 22 is able to discharge continuously (step S6) until the discharge termination condition (step S7, S7′) is satisfied. Although the internal resistance is likely to increase and the temperature Tsub of the sub battery 22 is likely to increase at initial stage of discharge, the number of times of occurrence of an initial state of discharge may be reduced, and thus temperature rise of the sub battery 22 is avoidable.

It is to be noted that the discharge start condition and the discharge termination condition may be set based on the same condition, for example, a condition that the temperature falls below the upper limit temperature Tc {threshold value temperature (preset temperature) or rated temperature} (discharge start condition) and a condition that the temperature exceeds the upper limit temperature Tc (the discharge termination condition), or the discharge start and termination conditions may be different conditions. It is to be noted that when both conditions are set based on the same condition, a hysteresis is preferably provided in order to avoid hunting.

As different conditions, the discharge start condition may include the condition that the temperature (the sub battery temperature Tsub) of the sub battery 22 falls below the upper limit temperature Tc, and the discharge termination condition may be that the remaining capacity SOCs of the sub battery 22 have zero values. Consequently, the energy of the main and sub batteries 21 and 22 may be fully consumed with reduced deterioration of the sub battery 22 having a higher internal resistance, and thus an apparatus to which the dual power supply system 10 is applied, that is, the electrically driven vehicle 12 may have an increased operation time such as a cruising range.

Preferably, the sub battery ECU 32 is controlled so that the discharge current Idsub from the sub battery 22 has the uniform current value Id1. In this manner, the discharge current Idsub is controlled so that discharge from the sub battery 22 having a higher internal resistance has the uniform current value Id1, and thus change in the current value may be reduced, temperature rise of the sub battery 22 is reduced and consequently, deterioration of the sub battery 22 may be reduced. Preferably, the discharge is controlled so that the discharge continues as long as possible and the range of fluctuation is reduced.

Here, the sub battery ECU 32 starts to discharge from the sub battery 22 when the internal resistance Rcdc at the time of charge of the main battery 21 is reduced and the charge loss of the main battery 21 is in low (high charging efficiency) state (for example, when the remaining capacity SOCm is reduced lower than the threshold value remaining capacity SOCmth, when the sub battery temperature Tsub is reduced lower than the upper limit temperature Tc, or when the main battery voltage Vmain is reduced to a charge start voltage Vmainstart corresponding to the threshold remaining capacity SOCmth) because the discharge start condition is satisfied. On the other hand, the sub battery ECU 32 terminates the discharge from the sub battery 22 when the charge loss is in high (low charging efficiency) state (for example, when the remaining capacity SOCm is higher than the threshold value remaining capacity SOCmth, when the remaining capacity SOCs of the sub battery 22 have zero values, or when the main battery voltage Vmain is higher than the charge start voltage Vmainstart corresponding to the threshold remaining capacity SOCmth). In this manner, the discharge from the sub battery 22 is made when the charge loss of the main battery 21 is in low (high charging efficiency) state, and thus discharge is avoidable in a low state of efficiency of power transmission from the sub battery 22 to the main battery 21, in other words, the transmission loss of discharge power from the sub battery 22 to the main battery 21 may be reduced.

After the sub battery 22 starts to discharge, the discharge is terminated when the charge efficiency of the main battery 21 is in low state, and thus discharge of the sub battery 22 (charge of the main battery 21) is avoidable in a low state of efficiency of power transmission from the sub battery 22 to the main battery 21.

The sub battery ECU 32 controls the discharge current Idsub from the sub battery 22 to be a current (the current value Id1 in FIG. 10, FIG. 12) lower than or equal to a current threshold value Idth, and thus temperature rise of the sub battery 22 is reduced and consequently, deterioration of the sub battery 22 may be reduced. The current threshold value Idth is set to a value lower than the rated current value.

The sub battery ECU 32 assumes that low (high charging efficiency) state of the charge loss of the main battery 21 occurs when the internal resistance Rcdc at the time of charge of the main battery 21 has a predetermined value, for example, the lowest reference resistance Rr (Rcdc≦Rr). Practically, it is difficult to measure Rcdc with high accuracy, and thus control is performed by reading a map that is created with SOCs and the main battery temperature Tmain. For example, the value of threshold remaining capacity SOCmth is referenced based on the main battery temperature Tmain, and it is determined that the internal resistance Rcdc at the time of charge becomes equal to the reference resistance value Rr.

In this manner, by adopting a configuration in which before the main battery 21 receives charge current from the sub battery 22, the main battery 21 is discharged until the internal resistance Rcdc at the time of charge of the sub battery 22 falls below a predetermined value, and then the charge current is received from the sub battery 22. Consequently, the power loss (the internal resistance Rcdc at the time of charge× charge current) of the main battery 21 due to the charge current is reduced, and the system efficiency, which is the total efficiency of the dual power supply system 10, may be increased.

Also, the main battery ECU 31 may assume that low (high charging efficiency) state of the charge loss of the main battery 21 occurs when the remaining capacity SOCm of the main battery 21 is, for example, 50% or higher and lower than or equal to the threshold remaining capacity SOCmth, for example, 65% or lower.

Because the main battery 21 having a lower internal resistance, which supplies power to the drive motor 25 is disposed near the drive motor 25 (the sub battery 22 which is not charged is disposed away from the drive motor 25), the lines 23, 24, which electrically connect the drive motor 25 and the main battery 21, may be shortened, and loss in the lines 23, 24 may be reduced at the time of power running of the drive motor 25. In addition, during the operation of the drive motor 25, loss in the lines 23, 24 may also be reduced when the regenerative power of the drive motor 25 is charged to the main battery 21 only through the lines 23, 24. In this manner, it is possible to shorten the lines 23, 24 between the drive motor 25 and the main battery 21, between which charge and discharge current flows frequently and the value of the current is high, and thus undesired radiation from the lines 23, 24 may also be reduced. In addition, reduction in the wiring weight and costs may be achieved because wiring for high current is thick and heavy.

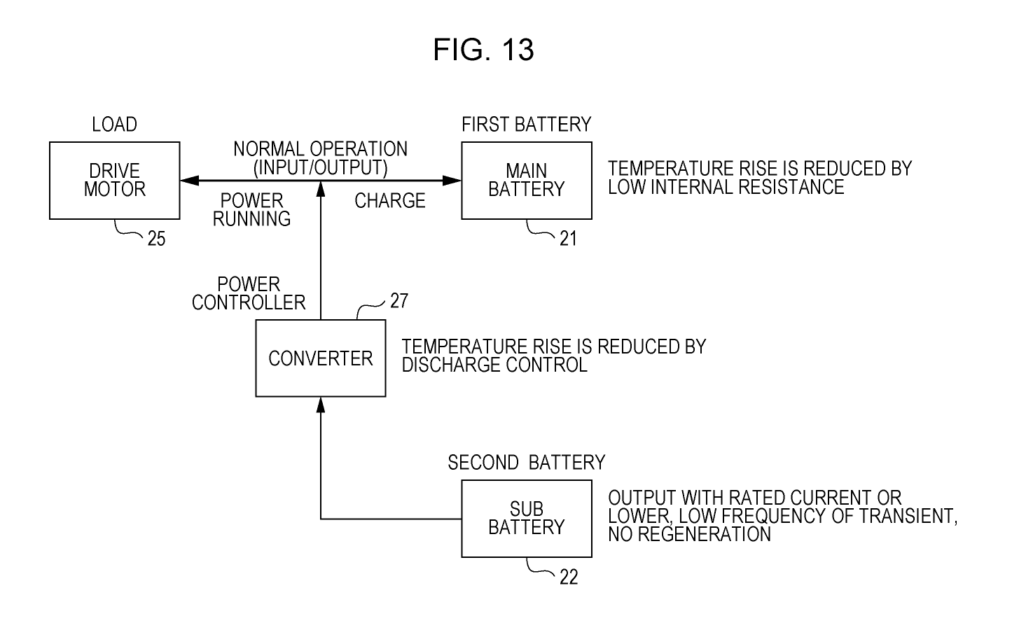

In the embodiment described above, as illustrated in FIG. 13 and FIGS. 5A to 5D, during normal operation (power input/output) of the drive motor 25 as a load, when the remaining capacity SOCm of the main battery 21 is lower than the threshold remaining capacity SOCmth (SOCm<SOCmth) or when the difference voltage ΔV=Vsub−Vmain between the main battery 21 and the sub battery 22 is higher than the discharge start difference voltage threshold value ΔVstartth1 (ΔV>ΔVstartth1), power running operation (discharge of the main battery 21 and the sub battery 22) is performed on the drive motor 25 by the main battery 21 and the sub battery 22 (FIG. 5A), and charging of regenerative power accompanying the regenerative operation is made to the main battery 21 only (FIG. 5B). Also, at the time of power running operation and regenerative operation when SOCm<SOCmth, the discharge current from the sub battery 22 is the uniform current Id1 lower than the rated current, and thus temperature rise of the sub battery 22 is avoidable, the temperature rise being caused by frequent increase and decrease in the charge and discharge current to and from the sub battery 22 as in related art.

Also, during normal operation (power input/output) of the drive motor 25 as a load, when the remaining capacity SOCm of the main battery 21 is higher than the threshold remaining capacity SOCmth (SOCm>SOCmth) or when the difference voltage ΔVi=Vmain−Vsub between the main battery 21 and the sub battery 22 is lower than the discharge start difference voltage threshold value ΔVstartth2 (ΔVi<ΔVstartth2), power running operation (discharge of the main battery 21 only) is performed on the drive motor 25 by the main battery 21 (FIG. 5C), and charging of regenerative power accompanying the regenerative operation is made to the main battery 21 only (FIG. 5D). At the time of power running operation and regenerative operation when SOCm>SOCmth, the value of charge and discharge current to and from the sub battery 22 is a zero value.

In either case (SOCm<SOCmth or SOCm>SOCmth), the main battery 21 operates with a low internal resistance, and thus temperature rise is reduced.

When SOCm<SOCmth, the converter 27 achieves discharge from the sub battery 22 to the secondary sides 2S, 2S′ using the uniform current Id1 lower than the rated current of the sub battery 22, and thus temperature rise of the sub battery 22 and the main battery 21 may be reduced. The sub battery 22 outputs discharge current lower than the rated current and is discharged with a uniform current, and thus frequency of occurrence of transient state is low and increase in the internal resistance due to occurrence of transient state is avoidable.

In either case (SOCm<SOCmth or SOCm>SOCmth), regenerative power is not supplied to the sub battery 22, and thus occurrence itself of transient state of the sub battery 22 may be reduced. Consequently, deterioration of the sub battery 22 may be reduced (avoided).

In the embodiment described above, the sub battery 22 is discharged only using the rated current or lower, preferably, the uniform current (discharge current) Id1 lower than the rated current. At the time of acceleration and at the time of uniform speed running of the electrically driven vehicle 12, the uniform discharge current Id1 is outputted to the drive motor 25 (see FIG. 5A). At the time of deceleration of the electrically driven vehicle 12, even when regenerative current is generated from the drive motor 25, the regenerative current is blocked by the diode D2 included in the converter 27, and all the output of the regenerative current and the discharge current Id1 of the sub battery 22 is charged to the main battery 21 having a lower internal resistance (see FIG. 5B). When the electrically driven vehicle 12 is stopped, output of the discharge current Id1 of the sub battery 22 is charged to the main battery 21. Consequently, occurrence of power loss due to repetition of transient state (charging and discharging) of the sub battery 22 is avoidable beforehand and resistance increase due to frequent repetition of start and stop of discharge is reduced, and thus temperature rise of the sub battery 22 may be reduced and deterioration of the sub battery 22 may be reduced (avoided).

It is to be noted that the present disclosure is not limited to the embodiment described above and may have various configurations naturally based on the description of the present disclosure.

The dual power supply system according to the present disclosure includes: a load; a first power storage battery that supplies power to the load; a second power storage battery that supplies power to the load and has a higher internal resistance than the first power storage battery has; and a power controller that controls electrical discharge of at least the second power storage battery. When the load is in operation, the power controller does not charge the second power storage battery.

According to the present disclosure, when the load is in operation, the second power storage battery having a higher internal resistance is not charged, and thus occurrence of charging transient state of the second power storage battery is avoided. Accordingly, temperature rise of the second power storage battery is reduced, and consequently, deterioration of the second power storage battery may be reduced.

In this case, preferably, the power controller starts to discharge the second power storage battery when a discharge start condition is satisfied, and the power controller continues to discharge the second power storage battery until a discharge termination condition is satisfied.

In this manner, once the second power storage battery starts to discharge, while discharge is made as well as while power is regenerated, for example, from the load to the first power storage battery, the second power storage battery is able to discharge continuously until the discharge termination condition is satisfied. Consequently, it is possible to reduce the number of times of occurrence of an initial state of discharge of the second power storage battery that is likely to have an increased internal resistance and temperature at the initial stage of discharge, and thus temperature rise of the second power storage battery is avoidable.

It is to be noted that the discharge start condition and the discharge termination condition may be set with based on the same condition, for example, a condition that the temperature falls below an upper limit temperature (discharge start condition) and a condition that the temperature exceeds the upper limit temperature (the discharge termination condition), or the discharge start and termination conditions may be set based on different conditions. It is to be noted that when both conditions are set based on the same condition, a hysteresis is preferably provided in order to avoid hunting.

As different conditions, the discharge start condition may include a condition that the second power storage battery has a temperature that falls below an upper limit temperature, and the discharge termination condition may be that a remaining capacity of the second power storage battery has a zero value. Consequently, the energy of the first and second power storage batteries may be fully consumed with reduced deterioration of the second power storage battery having a higher internal resistance, and thus an apparatus to which the dual power supply system is applied may have an increased operation time.

Also, preferably, the power controller controls a discharge current from the second power storage battery so that the discharge current has a uniform current value. In this manner, the discharge current is controlled so that discharge from the second power storage battery having a higher internal resistance is made using the uniform current value, and change in the current value may be thereby reduced, and thus temperature rise of the second power storage battery is reduced, and consequently, deterioration of the second power storage battery may be reduced.

In addition, when the first power storage battery is discharged until an internal resistance at a time of charge of the first power storage battery falls below a predetermined value, the discharge start condition may be satisfied and the power controller may cause the first power storage battery to receive a discharge current from the second power storage battery as a charge current. According to this, before the first power storage battery receives the discharge current from the second power storage battery as the charge current, the first power storage battery is discharged until the internal resistance at the time of charge of the first power storage battery falls below a predetermined value, and then the charge current is received from the second power storage battery. Consequently, the power loss (the internal resistance at the time of charge× charge current) of the first power storage battery due to the charge current is reduced, and the system efficiency, which is the total efficiency of the dual power supply system, may be increased.

In addition, when the first power storage battery is discharged until a remaining capacity of the first power storage battery falls below a predetermined value, the discharge start condition may be satisfied and the power controller may cause the first power storage battery to receive a discharge current from the second power storage battery as a charge current. According to this, before the first power storage battery receives the discharge current from the second power storage battery as the charge current, the first power storage battery is discharged until the remaining capacity of the first power storage battery falls below a predetermined value (condition equivalent to the above-described condition that the internal resistance at the time of charge falls below a predetermined value), and thus also in this case, the power loss (the internal resistance at the time of charge× charge current) of the first power storage battery due to the charge current is reduced, and the system efficiency, which is the total efficiency of the dual power supply system, may be increased.

Furthermore, preferably, the load is a drive motor that performs, during the operation, a power running operation or a regenerative operation, and the power controller causes only the first power storage battery to receive a regenerative current as a charge current, the regenerative current accompanying the regenerative operation of the drive motor. That is, a configuration is adopted in which the regenerative current accompanying the regenerative operation of the drive motor is received only by the first power storage battery having a lower internal resistance, and thus temperature rise and deterioration of the second power storage battery having a higher internal resistance is avoidable. In addition, it is possible to improve regeneration efficiency of the system.

The present disclosure also includes an electrically driven vehicle equipped with the dual power supply system described above. The drive motor, the first power storage battery, and the second power storage battery are disposed in order from the front to the rear of the electrically driven vehicle.

In this manner, the first power storage battery having a lower internal resistance, which supplies power to the drive motor is disposed near the drive motor (the second power storage battery having a higher internal resistance is disposed away from the drive motor), and thus a line, which electrically connects the drive motor and the first power storage battery, may be shortened, and loss in the line may be reduced at the time of power running of the drive motor. In addition, during the operation of the drive motor, the regenerative power of the drive motor is charged to the first power storage battery only, and thus loss in the line may be reduced even at the time of regeneration of the drive motor, and the line through which charge and discharge current flows frequently may be shortened, and consequently, undesired radiation from the line may also be reduced.

Obviously, numerous modifications and variations of the present invention are possible in light of the above teachings. It is therefore to be understood that within the scope of the appended claims, the invention may be practiced otherwise than as specifically described herein.

What is claimed is:

1. A dual power supply system, comprising:
a load;
a first power storage battery that supplies power to the load;
a second power storage battery that supplies power to the load and has a higher internal resistance than the first power storage battery has; and
a power controller that controls electrical discharge of at least the second power storage battery,
wherein when the load is in operation, the power controller does not charge the second power storage battery.

2. The dual power supply system according to claim 1,
wherein the power controller starts to discharge the second power storage battery when a discharge start condition is satisfied, and the power controller continues to discharge the second power storage battery until a discharge termination condition is satisfied.

3. The dual power supply system according to claim 2,
wherein the discharge start condition includes a condition that the second power storage battery has a temperature that falls below an upper limit temperature, and the discharge termination condition is that a remaining capacity of the second power storage battery has a zero value.

4. The dual power supply system according to claim 2,
wherein the power controller controls a discharge current from the second power storage battery so that the discharge current has a uniform current value.

5. The dual power supply system according to claim 2,
wherein when the first power storage battery is discharged until an internal resistance at a time of charge of the first power storage battery falls below a predetermined value, the discharge start condition is satisfied and the power controller causes the first power storage battery to receive a discharge current from the second power storage battery as a charge current.

6. The dual power supply system according to claim 2,
wherein when the first power storage battery is discharged until a remaining capacity of the first power storage battery falls below a predetermined value, the discharge start condition is satisfied and the power controller causes the first power storage battery to receive a discharge current from the second power storage battery as a charge current.

7. The dual power supply system according to claim 1,
wherein the load is a drive motor that performs, during the operation, a power running operation or a regenerative operation, and
the power controller causes only the first power storage battery to receive a regenerative current as a charge current, the regenerative current accompanying the regenerative operation of the drive motor.

8. An electrically driven vehicle equipped with the dual power supply system according to claim 7,
wherein the drive motor, the first power storage battery, and the second power storage battery are disposed in order from a front to a rear of the electrically driven vehicle.

9. A dual power supply system comprising:
a first power storage battery to supply power to a load and having a first internal resistance;
a second power storage battery to supply power to the load and having a second internal resistance higher than the first internal resistance; and
a power controller configured to control the second power storage battery to be charged and discharged, the power controller being configured to prohibit the second power storage battery from being charged while the load is in operation.

10. The dual power supply system according to claim 9,
wherein the power controller starts to discharge the second power storage battery in a case where a discharge start condition is satisfied, and
wherein the power controller continues to discharge the second power storage battery until a discharge termination condition is satisfied.

11. The dual power supply system according to claim 10,
wherein the discharge start condition comprises a condition that the second power storage battery has a temperature that falls below an upper limit temperature, and
wherein the discharge termination condition comprises a condition that a remaining capacity of the second power storage battery has a zero value.

12. The dual power supply system according to claim 10,
wherein the power controller controls the second power storage battery so that a discharge current from the second power storage battery has a uniform current value.

13. The dual power supply system according to claim 10,
wherein in a case where the first power storage battery is discharged until the first internal resistance at a time of charge of the first power storage battery falls below a predetermined value, the discharge start condition is satisfied and the power controller controls the first power storage battery to receive a discharge current from the second power storage battery as a charge current.

14. The dual power supply system according to claim 10,
wherein in a case where the first power storage battery is discharged until a remaining capacity of the first power storage battery falls below a predetermined value, the discharge start condition is satisfied and the power controller controls the first power storage battery to receive a discharge current from the second power storage battery as a charge current.

15. The dual power supply system according to claim 9, further comprising the load.

16. The dual power supply system according to claim 15,
wherein the load comprises a drive motor that performs, during the operation, a power running operation or a regenerative operation, and
wherein the power controller controls only the first power storage battery to receive a regenerative current as a charge current, the regenerative current accompanying the regenerative operation of the drive motor.

17. An electrically driven vehicle comprising:
the dual power supply system according to claim 16,
wherein the drive motor, the first power storage battery, and the second power storage battery are disposed in order from a front to a rear of the electrically driven vehicle.

18. The dual power supply system according to claim 16,
wherein in a case where a remaining capacity of the first power storage battery falls below a predetermined value, the power controller controls the second power storage battery to supply a discharge current from the second power storage battery to the drive motor while the drive motor performs the power running operation.

19. The dual power supply system according to claim 16,
wherein in a case where a remaining capacity of the first power storage battery falls below a predetermined value, the power controller controls the second power storage battery to supply a discharge current from the second power storage battery to the first power storage battery while the drive motor performs the regenerative operation.
